(19) United States
(12) Patent Application Publication
(10) Pub. No.: US 2026/0084707 A1
(43) Pub. Date: Mar. 26, 2026

(54) VEHICLE SECURITY ANALYSIS PLATFORM

(71) Applicant: University of Florida Research Foundation, Incorporated, Gainesville, FL (US)

(72) Inventors: Sandip Ray, Gainesville, FL (US); Bhagawat Baanav Yedla Ravi, Gainesville, FL (US)

(21) Appl. No.: 19/324,860

(22) Filed: Sep. 10, 2025

Related U.S. Application Data
(60) Provisional application No. 63/699,210, filed on Sep. 26, 2024.

(51) Int. Cl. B60W 50/04; B60R 16/023; B60R 16/03

(52) U.S. Cl. CPC B60W 50/04; B60R 16/0232; B60R 16/03; B60W 2050/041

(57) ABSTRACT

A system comprising a vehicle subsystem comprising a plurality of modules and a vehicle chassis, wherein the plurality of modules (i) comprises mechanical or electronic components that simulate one or more vehicle or vehicle electronic functionalities, (ii) comprises a modular form factor corresponding to the vehicle chassis, and (iii) is coupled to a vehicle computer; an attacker subsystem configured to attack a module of the plurality of modules; and a controller subsystem configured to control operation of the vehicle subsystem and the attacker subsystem by (i) providing (a) a vehicle control command to the vehicle subsystem and (b) an attacker control command to the attacker subsystem and (ii) receiving (a) vehicle feedback from the vehicle subsystem and (b) attacker feedback from the attacker subsystem.

### CROSS REFERENCE TO RELATED APPLICATION

This application claims the priority of U.S. Provisional Application No. 63/699,210, entitled “VEHICLE SECURITY ANALYSIS PLATFORM,” filed on Sep. 26, 2024, the disclosure of which is hereby incorporated by reference in its entirety.

### GOVERNMENT SUPPORT

This invention was made with government support under 2221900 awarded by the National Science Foundation. The government has certain rights in the invention.

### TECHNICAL FIELD

Various embodiments of the present disclosure relate to vehicle security, and more particularly to a platform for testing security of vehicular systems.

### BACKGROUND

Existing automotive security research and tools are mostly limited due to the lack of a roadmap in education and the unavailability of resources. Few hands-on learning platforms exist that teach automotive security exploration, and the hands-on learning platforms that do exist do not provide a holistic approach to security because they target specific components or a single subsystem. For example, compromising security on one component of a vehicle may affect other subsystems depending on the component attacked. As such, a variety of subsystems may behave differently compared to behavior observed by a stand-alone system attack. Accordingly, an effect on a subsystem that is compromised may have a larger impact on the system's overall behavior. Additionally, an expert's understanding of an attack may be limited to the functioning or behavior of specific subsystems under attack. However, overall effect on an outcome or behavior of a system may be difficult to determine. Applicant has identified many technical challenges and difficulties associated with automotive cybersecurity research and testing.

### BRIEF SUMMARY

Various embodiments described herein relate to methods, apparatus, systems, computing devices, computing entities, and/or the like for performing cybersecurity attack testing on vehicular systems.

According to some embodiments, a system comprises a vehicle subsystem comprising a plurality of modules and a vehicle chassis, wherein the plurality of modules (i) comprises mechanical or electronic components that simulate one or more vehicle or vehicle electronic functionalities, (ii) comprises a modular form factor corresponding to the vehicle chassis, and (iii) is coupled to a vehicle computer; an attacker subsystem configured to attack a module of the plurality of modules; and a controller subsystem configured to control operation of the vehicle subsystem and the attacker subsystem by (i) providing (a) a vehicle control command to the vehicle subsystem and (b) an attacker control command to the attacker subsystem and (ii) receiving (a) vehicle feedback from the vehicle subsystem and (b) attacker feedback from the attacker subsystem.

In some embodiments, the vehicle subsystem comprises one or more of a locomotion module group, a sensing module group, a communication module group, or a power management module. In some embodiments, the locomotion module group comprises one or more of a drivetrain module, a steering module, or a braking module. In some embodiments, (i) the drivetrain module is configured to control longitudinal motion associated with acceleration of the vehicle subsystem, (ii) the steering module is configured to control lateral motion of the vehicle subsystem, and (iii) the braking module is configured to control longitudinal motion associated with deceleration of the vehicle subsystem. In some embodiments, (i) the controller subsystem is further configured to provide a motion command to the steering module, the drivetrain module, or the braking module and (ii) the vehicle computer is further configured to receive feedback or performance data from the steering module, the drivetrain module, or the braking module based on an operation in accordance with the motion command.

In some embodiments, the sensing module group comprises one or more of a perception sensor, a localization sensor, a vehicle motion sensor, or a performance and health sensor. In some embodiments, (i) the perception sensor is configured to collect data that is associated with decision-making and path planning, (ii) the localization sensor is configured to provide navigation or driver assistance functionality, (iii) the vehicle motion sensor comprises a wheel speed sensor, a tire-pressure monitoring system sensor, a steering position sensor, or a steering torque sensor, and (iv) the performance and health sensor is configured to monitor performance and health of the vehicle subsystem. In some embodiments, the communication module group comprises one or more of an internal communication module, an external communication module, a remote communication module, or a redundant control module. In some embodiments, (i) the internal communication module is configured to transfer data between the plurality of modules within the vehicle subsystem, (ii) the external communication module is configured to send or receive data between the vehicle subsystem and an environmental infrastructure, (iii) the remote communication module is configured to send control data to, and receive a feedback message from, the vehicle subsystem or the attacker subsystem, and (iv) the redundant control module is configured to control safe vehicle operation. In some embodiments, the power management module is configured to manage an energy storage device in providing power to the vehicle subsystem. In some embodiments, the power management module comprises (i) a high voltage module that is associated with providing high voltage for traction and (ii) a low voltage module associated with one or more electronic control units or microcontrollers.

In some embodiments, the attacker subsystem comprises one or more of an attacker group module, a feedback sensor, an actuator, or a power management module. In some embodiments, the attacker group module comprises an ultrasonic transducer, a millimeter wave or infrared emitter, or a laser. In some embodiments, the feedback sensor comprises an ultrasonic sensor, a radar sensor, a light detection and ranging (LiDAR) sensor, or a camera that is configured to detect an attack on a sensor, process, or program that operates in conjunction with a target sensor that captures ground truth information. In some embodiments, a deviation from information provided by the feedback sensor with respect to the target sensor is representative of a successful attack. In some embodiments, a magnitude of the deviation corresponds to a strength of the successful attack. In some embodiments, the controller subsystem comprises a vehicle control parameters module that is configured to provide a parameter as the vehicle control command. In some embodiments, the parameter comprises velocity, heading, or steering angle. In some embodiments, the controller subsystem comprises an attacker control parameters module that is configured to provide a parameter as the attacker control command. In some embodiments, the parameter comprises trigger rate, trigger frequency, height, or azimuth.

### BRIEF DESCRIPTION OF THE DRAWINGS

Embodiments incorporating teachings of the present disclosure are shown and described with respect to the figures presented herein.

FIG. 1 is an example overview of a vehicle security analysis platform architecture in accordance with some embodiments of the present disclosure.

FIG. 2 is an example vehicle subsystem in accordance with some embodiments of the present disclosure.

FIG. 3 is a dataflow diagram of an example vehicle subsystem in accordance with some embodiments of the present disclosure.

FIG. 4A and FIG. 4B are schematics of example drivetrain modules in accordance with some embodiments of the present disclosure.

FIG. 5 is a schematic of an example vehicle subsystem in accordance with some embodiments of the present disclosure.

FIG. 6A is a schematic of an example parallel split braking module configuration in accordance with some embodiments of the present disclosure.

FIG. 6B is a schematic of an example diagonal split braking module configuration in accordance with some embodiments of the present disclosure.

FIG. 7 is a dataflow diagram of an example attacker subsystem in accordance with some embodiments of the present disclosure.

FIG. 8 is a dataflow diagram of an example controller subsystem in accordance with some embodiments of the present disclosure.

FIG. 9 is an example controller subsystem configuration in accordance with some embodiments of the present disclosure.

FIG. 10 is an example user controller interface for interacting with a controller subsystem in accordance with some embodiments of the present disclosure.

FIG. 11 is an example vehicle security analysis platform configuration in accordance with some embodiments of the present disclosure.

FIG. 12 is an example vehicle security analysis platform configuration in accordance with some embodiments of the present disclosure.

FIG. 13 is an example architecture of a cyber-physical system platform in accordance with some embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

As described above, there are many technical challenges and difficulties associated with automotive cybersecurity research and testing. Various embodiments of the present disclosure overcome such technical challenges and difficulties by providing various technical advancements and improvements. According to various embodiments of the present disclosure, a holistic platform is provided for testing security and overall functionality of vehicle systems.

Learning automotive cybersecurity in enough detail through existing platforms may be particularly challenging. For example, real vehicles do not offer convenience to test and operate. Real vehicles may also be cost-ineffective, include features and/or components that may be unnecessary for cybersecurity research, and lack modularity (e.g., do not allow the addition and/or removal of features). Software and hardware provided by real vehicles may also be closed source and hence do not offer configurability and/or flexibility to edit programs for specific tasks. Testing of real vehicles often involves collision testing and may not be practical for system security testing. Maintenance of real vehicles may also be a challenge that may call for professionals to ensure reliability.

On the other hand, conventional scaled-down vehicles do not accurately mimic a real vehicle. The dynamics of a real vehicle may also not be accurately captured by a conventional scaled-down vehicle because conventional scaled-down vehicles may be designed without consideration of occupant comfort or even an occupant. As such, components such as suspension systems and braking systems may not exist for conventional scaled-down vehicles. Furthermore, conventional scaled-down vehicles may lack electronics and/or automation features, thereby providing limited testing of actual vehicle sensors, ECUs, and/or actuators.

Another technical challenge and/or difficulty associated with automotive cybersecurity research and testing may be the lack of an interactive interface that is capable of controlling a vehicle and an attacker. For example, it may be desirable for a user to craft an attack on a vehicle where if the user does not succeed on a first attempt, the user may be provided with feedback that guides them toward a successful outcome to facilitate learning. Such feedback may indicate the success or failure of an attack. Furthermore, it may be desirable to determine the severity of an attack by quantifying outcomes via data acquired from a vehicle.

According to various embodiments of the present disclosure, a vehicle security analysis platform provides a learning environment for exploration in the field of automotive cybersecurity. In some embodiments, a vehicle security analysis platform comprises a vehicle subsystem, an attacker subsystem, and a controller subsystem. The vehicle subsystem may comprise a scaled vehicle with components of a full-scale vehicle to achieve realistic behavior. For example, the vehicle subsystem may mimic a full-scale vehicle in terms of electrical, mechanical, and/or electromechanical functions. The vehicle subsystem may also comprise features that allow users to install and remove modules for performing functions that are relevant to cybersecurity exploration. The attacker subsystem may be configured to perform cybersecurity attacks on the vehicle subsystem. In some embodiments, the attacker subsystem comprises hardware and/or software that are configured to subvert the vehicle subsystem. The attacker subsystem may also be modular in terms of hardware and software that may be modified to perform various advanced attacks. The controller subsystem may be configured to control the vehicle subsystem and the attacker subsystem. In some embodiments, the controller subsystem may be configured to send data to, and receive data from, the vehicle subsystem and the attacker subsystem. In some embodiments, the controller subsystem may be used to configure the vehicle subsystem and the attacker subsystem to perform experiments. Based on data received from the vehicle subsystem and/or the attacker subsystem, the controller subsystem may provide a user with feedback to evaluate severity of an attack that is being performed by the user on the vehicle subsystem via the attacker subsystem.

According to various embodiments of the present disclosure, the disclosed vehicle security analysis platform provides capabilities that conventional benchtop setups cannot provide. In some embodiments, the disclosed vehicle security analysis platform may be deployed in road and traffic architectures, unlike benchtop setups that are incapable of performing in real traffic scenarios. In some embodiments, the disclosed vehicle security analysis platform may be designed for mechanical and electrical safety that features energy-absorbing crash structures, safe operating voltages, and hazard-preventing components. In some embodiments, the disclosed vehicle security analysis platform may be configured to capture outcomes of vehicle dynamics, such as roll, pitch, dive, and squat, which define weight distribution and may comprise aspects of vehicle behavior and kinematics that are not captured by conventional scaled-down vehicles.

In some embodiments, the disclosed vehicle security analysis platform may be configured to generate data of vehicle dynamics that is very similar to a full-scale vehicle without having to use a full-scale vehicle. In some embodiments, the disclosed vehicle security analysis platform supports both scaled-down and actual market sensors to accommodate various operating conditions. That is, actual sensors may have limitations suited for real vehicles that may not be suitable for conventional benchtop setups. For example, radio detection and ranging (radar) systems may be impractical for benchtop setups due to their minimum readable range of one meter, making obstacles closer than one meter undetectable. Thus, a benchtop setup may need to be over two meters long. In some embodiments, the disclosed vehicle security analysis platform may use one or more network protocols, such as controller area network (CAN), local interconnect network (LIN), or FlexRay, etc., for internal communications, and 5G or dedicated short-range communications (DSRC), etc., for vehicle-to-vehicle (V2V) communications, which may not be feasible or possible on benchtop setups.

The disclosed vehicle security analysis platform may fulfill a need to provide hands-on physical interaction with an automobile rather than a virtual setup. For example, using a conventional software platform to generate a digital twin may demand excessive amounts of data to be provided to computers and extreme levels of mathematical modeling to achieve correlation. Accordingly, the disclosed vehicle security analysis platform may provide the experience of working with a real vehicle instead of interacting with a virtual environment.

### Example Technical Implementation of Various Embodiments

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable storage media (including volatile and non-volatile media).

A non-volatile computer-readable storage medium may include one or more magnetic and/or electro-mechanical storage devices, such as floppy disk(s), hard disk(s), magnetic tape, punch card(s), paper tape(s), optical mark sheet(s) (or any other physical medium with patterns of holes or other optically or mechanically detectable indicia), any other non-transitory magnetic medium, and/or the like. A non-volatile computer-readable storage medium may additionally or alternatively include one or more optical storage devices, such as compact disc read only memory (CD-ROM), compact disc-rewritable (CD-RW), any other non-transitory optical medium, and/or the like. A non-volatile computer-readable storage medium may additionally or alternatively include one or more read-only memory (ROM); programmable read-only memory (PROM); erasable programmable read-only memory (EPROM); electrically erasable programmable read-only memory (EEPROM), such as flash memory; and/or the like. In some examples, flash memory may comprise a set of field effect transistors and/or other devices or circuitry that implement serial and/or parallel NAND, NOR, and/or other hardware logic for storing data. In some examples, solid state storage (SSS), such as a solid state drive (SSD), flash drive, solid-state hybrid drives (SSHDs), and/or the like may include flash memory (SSHDs are a hybrid device that may include a hard disk and flash memory in some examples); and, in some examples, flash memory may be used as cache memory, implemented as a basic input output system (BIOS) chip or part of a BIOS chip, and/or the like. A non-volatile computer-readable storage medium may additionally or alternatively include 3D XPoint memory, non-volatile random access memory (NVRAM) (e.g., bridging random access memory (CBRAM), phase-change random access memory (PRAM), magnetoresistive random-access memory (MRAM), ferroelectric random-access memory (FeRAM)), racetrack memory, and/or the like. A non-volatile computer-readable storage medium may additionally or alternatively include one or more thermo-mechanical storage devices, such as Millipede memory; one or more molecular memory repositories; and/or the like.

A volatile computer-readable storage medium may include random access memory (RAM), dynamic random access memory (DRAM), static random access memory (SRAM), synchronous dynamic random access memory (SDRAM), cache memory (including various levels), register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### Example Vehicle Security Analysis Platform Architecture

According to some embodiments, a vehicle security analysis platform is provided. In some embodiments, the vehicle security analysis platform comprises a vehicle subsystem, such as a scaled-down vehicle model that comprises one or more functionalities of a corresponding real vehicle. In some embodiments, the vehicle security analysis platform further comprises an attacker subsystem that is configured with one or more functionalities that correspond to a role of an adversary. In some example embodiments, the attacker subsystem is configured to conduct one or more activities that subvert normal functionality of the vehicle subsystem. In some embodiments, the vehicle security analysis platform further comprises a controller subsystem that is configured to directly control the vehicle subsystem and the attacker subsystem. In some embodiments, the controller subsystem is configured to (i) receive feedback comprising data output and/or measurements from the vehicle subsystem and/or the attacker subsystem and (ii) generate, based on the feedback, data representative of an occurrence of an attack and/or a strength of the attack, which may be used to perform stronger attacks and/or intuitively formulate defense strategies against such attacks.

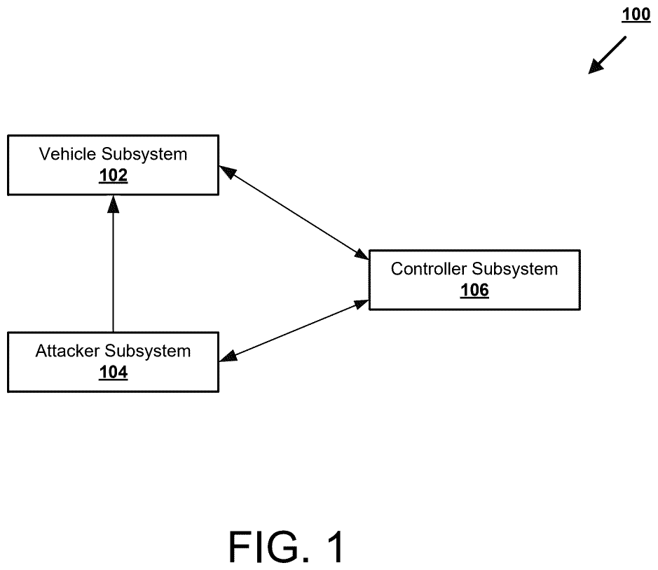

FIG. 1 is an example overview of a vehicle security analysis platform architecture 100 in accordance with some embodiments of the present disclosure. As depicted in FIG. 1, the vehicle security analysis platform architecture 100 comprises a vehicle subsystem 102, an attacker subsystem 104, and a controller subsystem 106. The vehicle subsystem 102 may comprise features and capabilities that are substantially similar to a real vehicle that the vehicle subsystem 102 may be modelled after. The attacker subsystem 104 may be configured to attack the vehicle subsystem 102 with an intention to subvert the vehicle subsystem 102. In the process of trying to attack the vehicle subsystem 102, a user that is in control of the attacker subsystem 104 may obtain knowledge about potential vulnerabilities in the vehicle subsystem 102. The controller subsystem 106 may be configured to control operation of the vehicle subsystem 102 and the attacker subsystem 104 by providing, modifying, and/or programming various parameters for the vehicle subsystem 102 (e.g., via vehicle controls) and the attacker subsystem 104 (e.g., via attacker controls). Accordingly, the vehicle security analysis platform architecture 100 may enable a user to exploit a spectrum of cybersecurity vulnerabilities or perform detection methodologies and/or mitigation strategies. In some embodiments, the vehicle security analysis platform architecture 100 further comprises infrastructure elements, such as roads, traffic signs, road signs, or buildings, etc.

In some embodiments, the vehicle security analysis platform architecture 100 enables a user to perform a spectrum of cybersecurity vulnerabilities, detection methodologies, and mitigation strategies across different systems and components. In some embodiments, a chassis of the vehicle subsystem 102 allows users to install additional modules to precisely replicate features for exploring cybersecurity vulnerabilities. In some embodiments, the chassis is designed for easy module integration that helps users interact, install, program, and test resiliency strategies. In some embodiments, the vehicle security analysis platform architecture 100 provides a learning environment that guides the user towards achieving a successful attack, an effective detection and mitigation strategy. In some embodiments, the vehicle subsystem 102 comprises a drivetrain unit that is a dual motor type with an internal encoder and an external encoder, wherein the internal encoder is for providing ground truth information and the external encoder is used to perform and test security vulnerabilities. In some embodiments, the vehicle subsystem 102 comprises a steering module that allows a steering position actuator, a steering assist actuator, a position sensor, and a torque sensor to be changed and upgraded. In some embodiments, the vehicle subsystem 102 comprises a braking system that is a configurable multi-split type that allows a user to choose a kind of split type to perform cybersecurity studies on each kind.

In some embodiments, the vehicle subsystem 102 comprises a vehicle computer that is configured to control, communicate, and acquire data for typical vehicle functions, and is specifically programmed for security evaluation and the development of detection and mitigation strategies. In some embodiments, the vehicle subsystem 102 comprises a chassis, a drivetrain module, a steering module, a braking module, suspension, a power management module, a vehicle computer, and other additional modules that have physical features that allow the installation of attack evaluator units that control attacks and transmit relevant data. In some embodiments, the attacker subsystem 104 comprises one or more attacker modules that are based on a type of attack, wherein (i) the one or more attacker modules are associated with either an internal entity or an external entity based on the type of attack, (ii) the internal entity or the external entity interacts with the vehicle subsystem via modules mounted on a vehicle chassis associated with the vehicle subsystem to subvert the performance of the vehicle subsystem, and (iii) an attacker interacts with the vehicle subsystem that retains the functionality of a real vehicle. In some embodiments, the controller subsystem 106 comprises unified controller controls, coordinates, and is configured to communicate with the attacker subsystem and the vehicle subsystem for cybersecurity exploration.

### Example Vehicle Subsystem

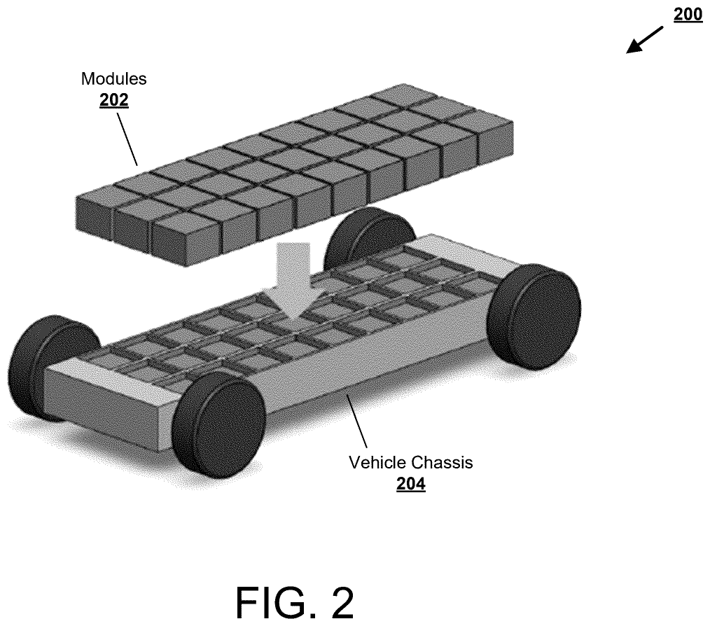

FIG. 2 is an example vehicle subsystem 200 in accordance with some embodiments of the present disclosure. The vehicle subsystem 200 is an example of the vehicle subsystem 102 of FIG. 1. The vehicle subsystem 200 may comprise a portable plug-and-play platform where vehicular components and/or electronics, in the form of modules 202, may be modularly installed onto a vehicle chassis 204 to provide a configuration that may satisfy one or more experiment criteria. In some embodiments, the modules 202 may comprise mechanical and/or electronic components that simulate actual vehicle and/or vehicle electronic functionalities. The modules 202 may comprise a modular form factor that allows modules 202 to be independently replaced and/or exchanged on the vehicle chassis 204. As depicted in FIG. 2, the vehicle chassis 204 comprises a modular design that is capable of accommodating modules 202 onto the vehicle subsystem 200. The vehicle chassis 204 may comprise physical features that allow installation and communication coupling of modules 202 with vehicle chassis 204. As such, the vehicle chassis 204 may accommodate modules 202 comprising desired automotive components that may be interchangeably installed in a plug-and-play manner.

A module (of modules 202) by itself or a combination of modules 202 may be configured on the vehicle chassis 204 to perform relevant experiments and tests. In some embodiments, the vehicle chassis 204 allows users to install modules 202 to configure or replicate features for exploring cybersecurity vulnerabilities. In some embodiments, modules 202 may comprise an attacker subsystem (e.g., attacker subsystem 104) that is installed onto the vehicle chassis 204 to simulate a malicious third-party component.

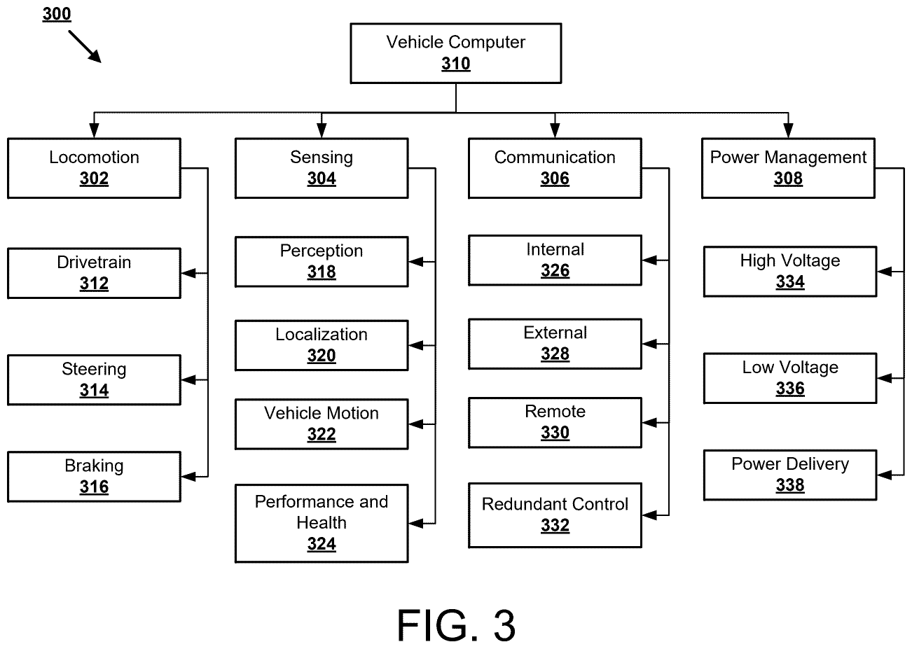

FIG. 3 is a dataflow diagram of an example vehicle subsystem 300 in accordance with some embodiments of the present disclosure. The vehicle subsystem 300 is an example of the vehicle subsystem 102 of FIG. 1. Vehicle subsystem 300 comprises a locomotion module group 302, a sensing module group 304, a communication module group 306, and a power management module 308 that are coupled to a vehicle computer 310. In some embodiments, the locomotion module group 302 comprises modules that are configured to physically put the vehicle subsystem 300 in motion. For example, the locomotion module group 302 comprises a drivetrain module 312, a steering module 314, and a braking module 316.

In some embodiments, the drivetrain module 312 is configured to control longitudinal motion associated with acceleration of the vehicle subsystem 300. In some embodiments, the steering module 314 is configured to control lateral motion of the vehicle subsystem 300. In some embodiments, the braking module 316 is also configured to control longitudinal motion but in the form of deceleration. Accordingly, the mobility of the vehicle subsystem 300 may be provided and/or controlled by a combination of the drivetrain module 312, the steering module 314, and the braking module 316. For example, for the vehicle subsystem 300 to move and turn, both longitudinal and lateral motion may be present. The vehicle subsystem 300 may respond to longitudinal and lateral dynamics in terms of roll, pitch, and yaw. Such dynamic responses may be important for mimicking the behavior of a full-scaled car.

In some embodiments, the drivetrain module 312 comprises two motors that power individual wheels of an axle. The drivetrain module 312 may be mounted in a front position of a vehicle chassis to facilitate front-wheel drive and/or all-wheel drive applications. In some embodiments, the drivetrain module 312 may comprise one or more motor controllers that control the speed of the two motors. In some embodiments, the one or more motor controllers may be configured with their respective microcontrollers that process and analyze data from drivetrain sensors. The drivetrain module 312 may further comprise features that allow a user to install attacker modules that subvert the normal functioning of motor encoders.

In some embodiments, the drivetrain module 312 comprises one or more motors powering both rear axles using a differential or independently respectively. For example, the drivetrain module 312 may comprise brushless direct current (BLDC) motors that run on respective motor drivers or electronic speed controllers (ESC). A motor may comprise a dedicated (internal) encoder that is configured inside a gearbox to provide feedback to an ESC. The drivetrain module 312 may further comprise an additional (external) encoder that is exterior to a gearbox that has the same function, however, that allows a user to attack the external encoder. The vehicle subsystem 300 may be configured to either use the internal encoder or the external encoder.

In some embodiments, motors may be configured with temperature sensors to obtain temperature values, which may be representative of load on the motors. As such, motor temperature or load information may be used to perform a root cause analysis on a cybersecurity attack. Power from the motors may be transferred to the wheels via a mechanical transmission system, such as a belt drive, gear drive etc., or may also be transferred directly from a motor shaft.

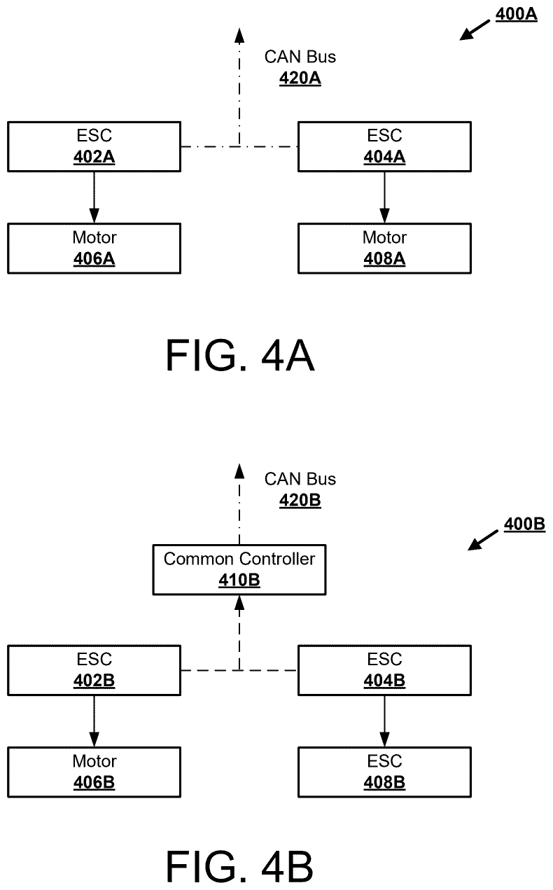

FIG. 4A is a schematic of an example drivetrain module 400A in accordance with some embodiments of the present disclosure. The drivetrain module 400A is an example of the drivetrain module 312 of FIG. 3. The drivetrain module 400A comprises ESC 402A and ESC 404A that are coupled to motors 406A and 408A, respectively. The motors 406A and 408A may be coordinated directly by using a communication protocol, such as CAN, via CAN bus 420A to communicatively connect with the motors 406A and 408A via ESC 402A and ESC 404A.

FIG. 4B is a schematic of an example drivetrain module 400B in accordance with some embodiments of the present disclosure. The drivetrain module 400B is an example of the drivetrain module 312 of FIG. 3. The drivetrain module 400B comprises ESC 402B and ESC 404B that are coupled to motors 406B and 408B, respectively. The motors 406A and 408A may be coordinated indirectly through a common controller 410B that is configured to facilitate communication using a communication protocol, such as CAN, between CAN bus 420A and ESC 402B and ESC 404B.

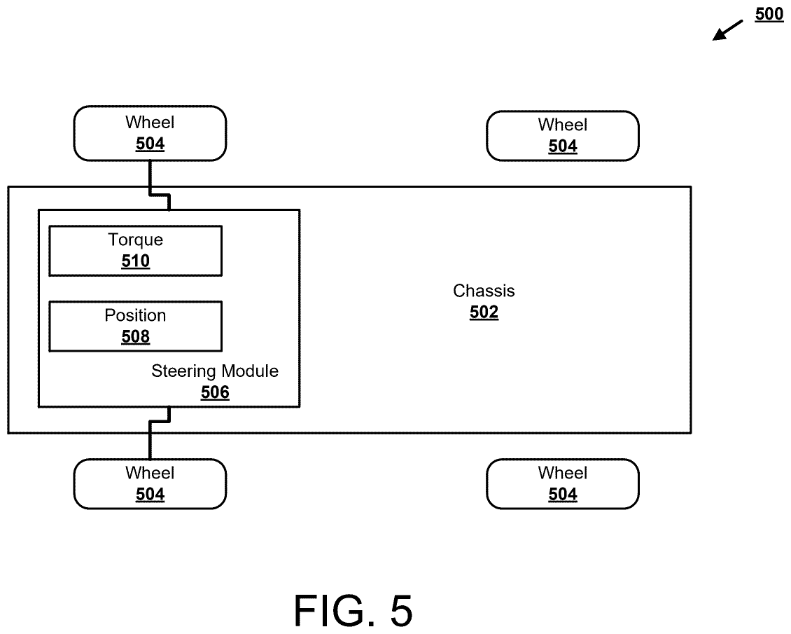

FIG. 5 is a schematic of an example vehicle subsystem 500 in accordance with some embodiments of the present disclosure. The vehicle subsystem 500 comprises a chassis 502, a plurality of wheels 504, and a steering module 506. The steering module 506 is an example of the steering module 314 of FIG. 3. The steering module 506 comprises a position sensor 508 and a torque sensor 510. In some embodiments, the steering module 506 further comprises a steering position actuator and an assist actuator. The steering position actuator may be configured to translate steering angle to a steering rack. The assist actuator may be configured to provide steering assist to the steering module 506. Steering angle information may be provided by instructions from a controller subsystem (e.g., controller subsystem 106). The position sensor 508 may be configured to capture steering angle information from the steering position actuator. The torque sensor 510 may be configured to measure torque provided by the steering position actuator. In some embodiments, a microcontroller may be configured to manage power provided to the assist actuator based on the values obtained from the torque sensor 510.

In some embodiments, the braking module 316 comprises a brake master that is configured to provide brake pressure to individual slave pistons to brakes. The braking module 316 may further comprise a brake modulator that provides a configurable brake pressure distribution system that may be configured by a user to change the format of the brake force distribution between parallel, diagonal, or axle-specific. The braking module 316 may comprise a configurable multi-split type system that allows a user to choose the kind of split type to perform cybersecurity studies on each kind. In some embodiments, the brake actuation and configuration management may be handled by a dedicated microcontroller.

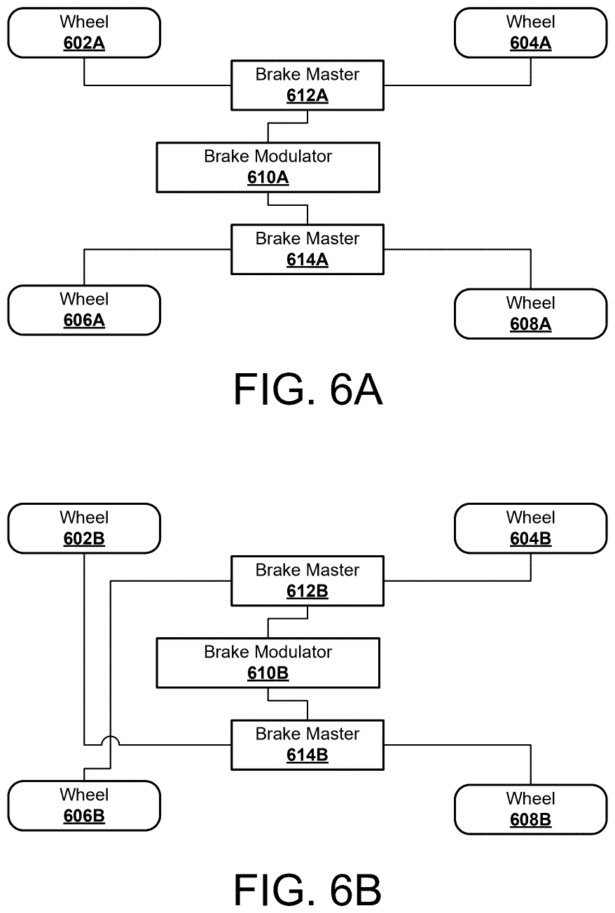

FIG. 6A is a schematic of an example parallel split braking module configuration 600A in accordance with some embodiments of the present disclosure. The parallel split braking module configuration 600A comprises a brake modulator 610A that is configured to provide parallel brake force distribution to wheels 602A, 604A, 606A, and 608A via brake master 612A and brake master 614A, respectively.

FIG. 6B is a schematic of an example diagonal split braking module configuration 600B in accordance with some embodiments of the present disclosure. The diagonal split braking module configuration 600B comprises a brake modulator 610B that is configured to provide independent diagonal brake force distribution to wheels 602B and 608B via brake master 614B and to wheels 604B and 606B via brake master 612B.

Referring back to FIG. 3, the sensing module group 304 may comprise sensors that are configured to provide data related to the environment of the vehicle subsystem 300. The sensing module group 304 comprises perception sensors 318, localization sensors 320, vehicle motion sensors 322, and performance and health sensors 324. The perception sensors 318 may be configured to collect data for decision-making and path planning. The localization sensors 320 may comprise inertial measurement unit (IMU), global positioning system (GPS), and/or compass units that may be used for navigation and/or advanced driver-assistance system (ADAS) applications. The vehicle motion sensors 322 may comprise wheel speed sensors, tire-pressure monitoring system (TPMS) sensors, steering position sensors, and/or steering torque sensors. In some embodiments, the vehicle motion sensors 322 may be used in conjunction with the localization sensors 320 to provide driver assistance. The performance and health sensors 324 may be configured to monitor performance and health of the vehicle subsystem 300. In some embodiments, the performance and health sensors 324 may comprise temperature sensors used to analyze the state of motors, batteries, and/or other electronics in the vehicle subsystem 300. In some embodiments, the performance and health sensors 324 may comprise pressure sensors that are configured to measure oil pressure, brake pressure, etc. As such, the performance and health sensors 324 may obtain and provide information to a user for identifying root causes of faults and failures.

The vehicle subsystem 300 may further comprise a suspension system of an independent type with coil springs and dampers, which may allow the vehicle to distribute weight and manage grip on the road. The vehicle subsystem 300 may further comprise outboard suspension components that include uprights for mounting brake calipers, tire pressure monitoring systems, and wheel speed sensors. The wheel speed sensors and the TPMS provide indirect and direct tire pressure sensors respectively.

In some embodiments, the communication module group 306 comprises modules that may be configured to transfer data from one system, subsystem, group, and/or module to another. As further depicted by FIG. 3, the communication module group 306 comprises internal communication modules 326, external communication modules 328, remote communication modules 330, and redundant control (safety) modules 332. In some embodiments, internal communication modules 325 are configured to transfer data between modules within the vehicle subsystem 300. Internal communication modules 326 used within the vehicle subsystem 300 may be realized through various forms of serial communications, such as CAN, associated with microcontrollers, or other forms of communication protocols that allow users to analyze and evaluate data transfer efficiencies. In some other embodiments, internal communication modules 326 may also be realized by using wireless forms of communication.

In some embodiments, the external communication modules 328 comprise modules that are configured to send and/or receive data between the vehicle subsystem 300 and environmental infrastructure, which may be referred to as vehicle-to-everything (V2X) communication. For example, two or more vehicle subsystems in case of platooning and/or cooperative adaptive cruise control (CACC). Vehicles and the external entities, such as roadside units, may be equipped with communication systems that may communicate with the external communication modules 328. In some embodiments, the external communication modules 328 may support DSRC, automotive cellular, etc. In some embodiments, the external communication modules 328 may also support wireless key.

In some embodiments, the remote communication modules 330 are configured to send control data to, and receive feedback messages from, the vehicle subsystem 300 and one or more attacker subsystems (e.g., attacker subsystem 104). The remote communication modules 330 may comprise a dedicated communication module that is independent of the external communication modules 328 to isolate real time control activities and parameter updates from communications of external communication modules 328 such that true performance of an attack, attack detection method, or a mitigation strategy may be captured.

In some embodiments, the redundant control modules 332 is configured to control safe vehicle operation in the event of a failure or loss of a primary remote control. The redundant control modules 332 may provide functionality for retaining a vehicle's basic controls of locomotion to bring the vehicle subsystem 300 to a safe stop and/or activating a kill switch that cuts power to one or more modules.

In some embodiments, the power management module 308 may be configured to manage energy storage devices, such as a battery, for providing power to the vehicle subsystem 300. The power management module 308 comprises a high voltage module 334 for providing high voltage for traction and in some cases heating and cooling, and a low voltage module 336 for electronic control units (ECUs) or microcontrollers to control other modules. Sensing, communication, and/or lateral locomotion may use low voltages to operate. The high voltage module 334 and the low voltage module 336 may be equipped with DC-DC converters that provide appropriate voltages. A user may be able to control such voltages, such as high voltage to analyze the performance of a traction motor.

In some embodiments, the power management module 308 may comprise a plurality of battery modules that form a battery pack. The plurality of battery modules may be managed by their respective battery management systems (BMS) and a central controller comprising a power delivery module 338. The central controller may be governed by a dedicated microcontroller. In some embodiments, the plurality of battery modules may comprise various safety protocols that are managed by the BMS.

In some embodiments, the vehicle computer 310 is configured to manage the overall function of the vehicle subsystem 300, control various groups, modules, and/or subsystems, and allow connections with additional modules. The vehicle computer 310 may also be configured to acquire and store data and communicate (e.g., wirelessly) with a controller subsystem (controller subsystem 106) to receive and transmit data. For example, the vehicle computer 310 may be configured, via control commands from the controller subsystem, to facilitate control, communication, and data acquisition for vehicle functions, and may be specifically programmed for security evaluation and development of detection and mitigation strategies. The vehicle computer 310 may be configured to perform a variety of functions to ensure that the vehicle subsystem 300 operates effectively based on commands provided from the controller subsystem.

The vehicle computer 310 may be configured to control operation of the vehicle subsystem 300 based on vehicle control commands provided from a controller subsystem to the vehicle subsystem 300. Examples of functions that may be facilitated with vehicle control commands provided from a controller subsystem to the vehicle computer 310 may include chassis control, internal communication, external communication, decision-making, and real time analysis and diagnostics.

In some embodiments, chassis control comprises the vehicle computer 310 providing motion commands to the steering module 314, drivetrain module 312, and/or braking module 316. The vehicle computer 310 may receive feedback and/or performance data from the steering module 314, drivetrain module 312, and/or braking module 316 based on operation in accordance with the motion commands. The vehicle computer 310 may be further configured to allow users to program and analyze an attack during any experiment on the steering module 314, drivetrain module 312, and/or braking module 316. Chassis control may be extended to attachable modules, such as active suspension and active aero components.

In some embodiments, internal communication comprises communication between modules (e.g., via internal communication modules 326) within the vehicle subsystem 300. For example, internal communication may be implemented using a CAN protocol where each module may comprise a microcontroller and a CAN transceiver.

In some embodiments, external communication comprises the vehicle computer 310 communicating wirelessly (e.g., via external communication modules 328) with external entities, such as attackers (e.g., attacker subsystem 104) and/or a controller (e.g., controller subsystem 106). External communications may also comprise over-the-air updates that are sent wirelessly to the vehicle subsystem 300 from either a controller or through a personal computer.

In some embodiments, data acquisition comprises configuring the vehicle computer 310 to acquire and store data. A user may program specific parameters that are of interest for a specific experiment. Data acquired by the vehicle computer 310 may be received from sensors and/or input commands from a controller or attacker.

In some embodiments, decision-making comprises the vehicle computer 310 making decisions in autonomous and semi-autonomous maneuvers based on data acquired by the vehicle computer 310 via data acquisition. In some embodiments, decision-making comprises decisions related to path planning and navigation and sending appropriate commands to modules and/or actuators.

In some embodiments, real time analysis and diagnostics comprise acquiring data over the operation of the vehicle subsystem 300, such as performance, efficiency and effectiveness of an attack, detection, and mitigation mechanism conducted.

The vehicle subsystem 300 is not limited to the above-mentioned modules. As disclosed herewith, a vehicle subsystem 300 comprising a vehicle chassis may accommodate, plug and play with other modules that enhance the functioning of the vehicle subsystem 300, and may be added at any time. In some embodiments, certain modules, such as the drivetrain module 312, steering module 314, braking module 316, the power management module 308, and the vehicle computer 310, may comprise a minimum set of modules for providing certain functionalities and may be fixed to the vehicle chassis at designated mounting points. However, the certain modules may be tuned from the location where they are installed and replaced in the event of failure or degradation.

### Example Attacker Subsystem

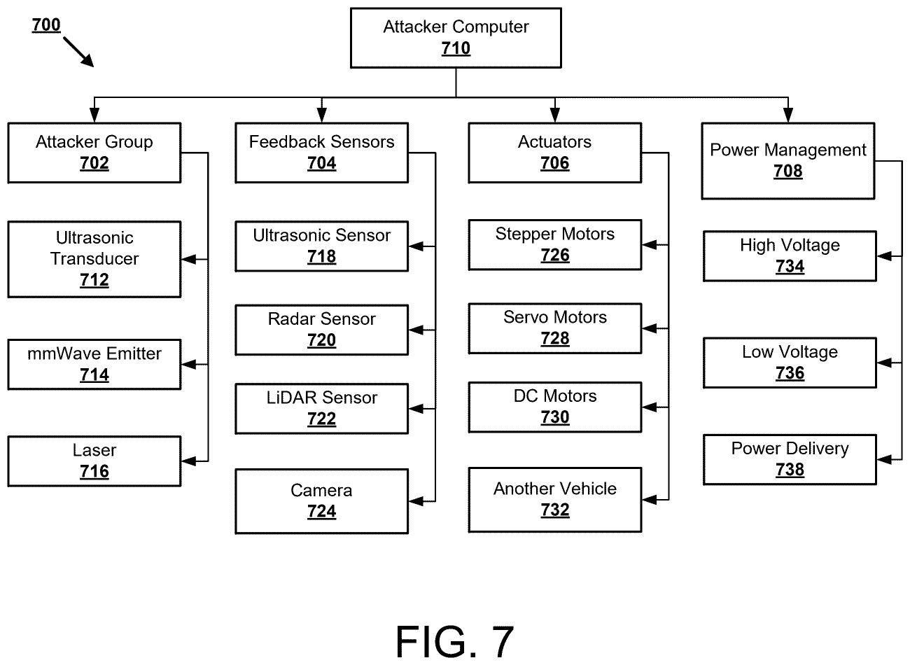

FIG. 7 is a dataflow diagram of an example attacker subsystem 700 in accordance with some embodiments of the present disclosure. The attacker subsystem 700 is an example of the attacker subsystem 104 of FIG. 1. The attacker subsystem 700 may be configured to allow a user to attack a vehicle (e.g., vehicle subsystem 102). As depicted in FIG. 7, the attacker subsystem 700 comprises an attacker group module 702, feedback sensors 704, actuators 706, and a power management module 708.

In some embodiments, the attacker group module 702 comprises modules that are configured to carry out specific types of attacks on a vehicle subsystem. As further depicted in FIG. 7, the attacker group module 702 comprises an ultrasonic transducer 712, a millimeter wave (mmWave) and/or infrared emitter 714, and a laser 716. Modules in the attacker group module 702 may comprise devices that operate based on flaws and/or voids in an operating window of a device, process, or program that is being attacked. For example, in the context of sensors, a module of the attacker group module 702 may be operated at a setup that subverts normal functioning of a sensor, which may be carried out by using man-in-the-middle attacks, denial-of-service attacks, etc. In another example, if an attack is performed on a target ultrasonic sensor, an attacker may send malicious pulses towards the target ultrasonic sensor before an original echo reaches the target ultrasonic, thereby causing the target ultrasonic sensor to capture an echo before its original echo leading to false detection. Attacks on perception systems may be performed via injecting malicious messages that may lead to false detection or perception of an environment. One or more modules in the attacker group module 702 may be used individually or as a combination. For example, attacks on sensor fusion-based systems may use more than one module in the attacker group module 702 to perform an attack. The attacker group module 702 is coupled to an attacker computer 710 that communicates with a controller subsystem (e.g., controller subsystem 106) to allow the attacker subsystem 700 to receive control commands and send feedback messages to the controller subsystem.

In some embodiments, the feedback sensors 704 may comprise sensors and software evaluators that are configured to detect an attack on a sensor, process, or program that operates in conjunction with a target sensor that captures ground truth information. The feedback sensors 704 comprise an ultrasonic sensor 718, a radar sensor 720, a light detection and ranging (LiDAR) sensor 722, and a camera 724. Feedback sensors 704 may also comprise touch probes, magnetic encoders, or optical encoders etc. To provide ground truth information, the feedback sensors 704 may be immune to attacks. As such, a deviation from information provided by the feedback sensors 704 with respect to a target sensor may be representative of a successful attack. In some embodiments, a magnitude of such deviation may be used to evaluate the strength of an attack. As an example, in the context of attacks on ultrasonic sensors for determining stop distances, the ultrasonic transducer 712 may be configured to operate at a window that performs an attack on a target ultrasonic sensor mounted on a vehicle. Functionality of the ultrasonic sensor may be visually seen if the vehicle stops at a location other than its intended stop distance. However, precise numerical values may provide subtle deviations that are measurable for providing meaningful feedback to a user facilitating the attack.

The actuators 706 comprise stepper motors 726, servo motors 728, DC motors 730, and another vehicle 732 that is configured to position the attacker subsystem 700 appropriately relative to a sensor on a target vehicle. For example, the attacker subsystem 700 may be configured on another vehicle and operated close to a target vehicle to perform attacks.

In some embodiments, the power management module 708 is configured to provide power to the attacker group module 702 and feedback sensors 704 to perform the various aforementioned attacks using high voltage 734 and low voltage 736. For example, an attacker may vary in form and function based on the kind of experiment that is of interest, where some may be free from a power cable and while other cases, a dedicated power source, such as a battery, may be used. The power management module 708 further comprises power delivery 738 that configures supplying power to modules.

The attacker computer 710 may be configured to control operation of the attacker subsystem 700 based on attacker control commands provided from a controller subsystem to the attacker subsystem 700. The following provides examples of functions that may be facilitated with attacker control commands provided from a controller subsystem to the attacker computer 710:

Internal sensor attackers: may target sensors that collect data of a vehicle. For example, wheel speed, temperature of modules and components within the vehicle (such as battery, motor etc.), brake pressure sensors, IMU, compass, etc.

Internal communication attackers: may target internal communication modules (e.g., internal communication modules 326, such as CAN, LIN, FlexRay, isolated serial peripheral interface, WiFi, or Bluetooth Low Energy) that may be responsible for data flow within various modules and components within a vehicle.

External sensor attackers: may target environmental sensors, such as ADAS sensors and sensors that support autonomous driving, such as ultrasonic sensors, radar, LiDAR, camera, GPS, etc.

External Communication Attackers: may target external communication modules (e.g., external communication modules 328) responsible for V2X communications, which may include DSRC, cellular, radio frequency identification (RFID), WiFi, Bluetooth etc.

The attacker subsystem 700 is not limited to the above-mentioned modules. As disclosed herewith, an attacker subsystem 700 may accommodate, plug and play with other modules that enhance the functioning of the attacker subsystem 700, and may still be added at any time.

### Example Controller Subsystem

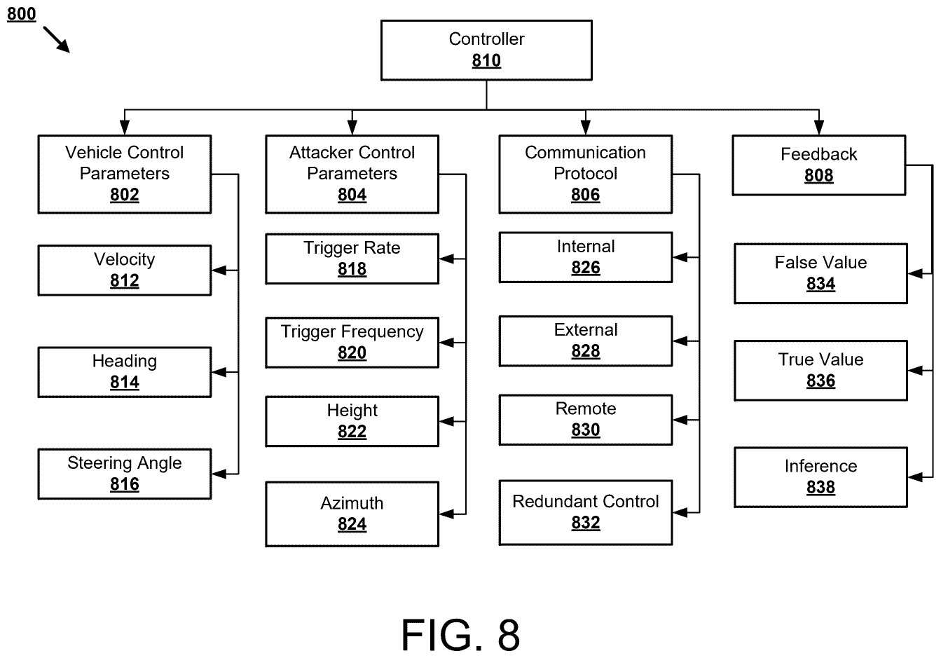

FIG. 8 is a dataflow diagram of an example controller subsystem 800 in accordance with some embodiments of the present disclosure. The controller subsystem 800 is an example of the controller subsystem 106 of FIG. 1. In some embodiments, the controller subsystem 800 may comprise modules that allow a user to control and extract information from a vehicle subsystem (e.g., vehicle subsystem 102) and an attacker subsystem (e.g., attacker subsystem 104). As depicted in FIG. 8, the controller subsystem 800 comprises a vehicle control parameters module 802, an attacker control parameters module 804, a communication protocol module 806, and a feedback module 808.

In some embodiments, the vehicle control parameters module 802 is configured to provide parameters as vehicle control commands to a vehicle subsystem. The parameters may comprise velocity 812, heading 814, and steering angle 816. The types of parameters that may be provided to the vehicle subsystem may further comprise customizable parameters that are provided/generated by a user and/or derived based on mathematical operations.

In some embodiments, the attacker control parameters module 804 is configured to provide parameters as attacker control commands to an attacker subsystem to perform attacks on the vehicle subsystem. Such parameters comprise trigger rate 818, trigger frequency 820, height 822, and azimuth 824.

In some embodiments, the communication protocol module 806 is configured to allow a user to configure internal 826, external 828, remote 830, and redundant control 832 communications for a vehicle subsystem. As such, the communication protocol module 806 may allow a user to evaluate performance and responsiveness of a vehicle subsystem. Additionally, the communication protocol module 806 may allow the user to test a plurality of communication protocol combinations for building security resiliency designs by exploiting a combination of communication protocols.

In some embodiments, the feedback module 808 is configured to provide feedback of attacks on a vehicle subsystem to a user for post processing (e.g., evaluation of success and strength of attacks). The types of feedback comprise false value 834, true value 836, and inference 838.

In some embodiments, the controller subsystem 800 may be further configured to program and flash codes to a vehicle subsystem and an attacker subsystem to a provide a user with a variety of use cases. In some embodiments, the controller subsystem 800 comprises a modular software design that allows a user to use blocks of code that add and remove functionality from a vehicle subsystem and an attacker subsystem. As such, a user may be provided with freedom to create parameters that suit desired experiments and try a variety of parameter combinations to innovate attack scenarios, attack detection, and mitigation strategies. In some embodiments, the controller subsystem is configured to facilitate over-the-air updates to vehicle subsystems and attacker subsystems.

In some embodiments, the controller subsystem 800 is deployed on a computing device, such as a personal computer. An interactive GUI may be provided on the computing device to allow a user to write and edit programs; however, some aspects of realism, such as driving a vehicle, may not be present. In some embodiments, the controller subsystem 800 may comprise a steering wheel console and gas/brake pedals to simulate the feel of driving a vehicle. In some further embodiments, a console may provide feedback to the user adding realism. However, a steering wheel console and gas/brake pedals alone provide limited functionalities with respect to writing and editing custom code.

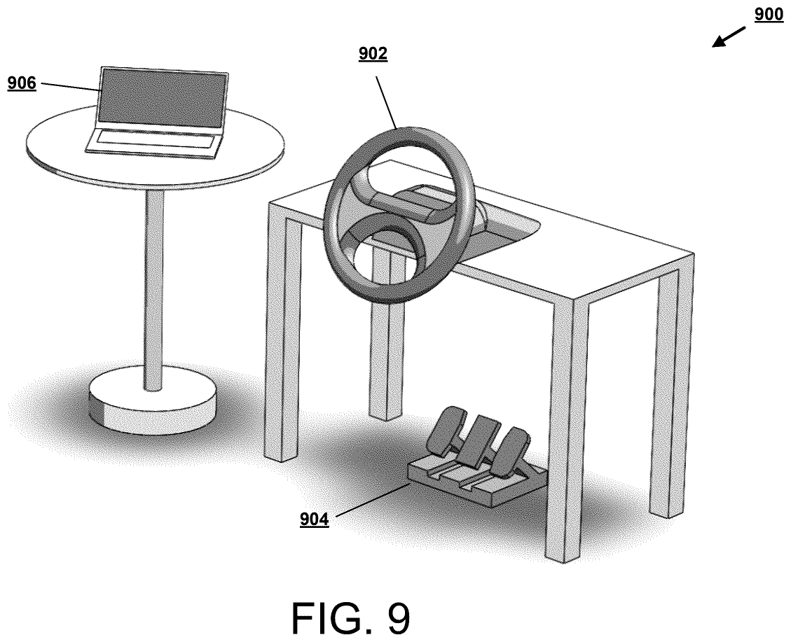

FIG. 9 is an example controller subsystem 900 configuration in accordance with some embodiments of the present disclosure. In some embodiments, a user experience on a computing device 906 may be enhanced by incorporating a steering wheel 902 and pedals-based 904 console to offer an interactive and realistic experience. As such, a user may be provided with combined benefits from both a computing device 906 and a steering wheel 902 and pedals-based 904 console.

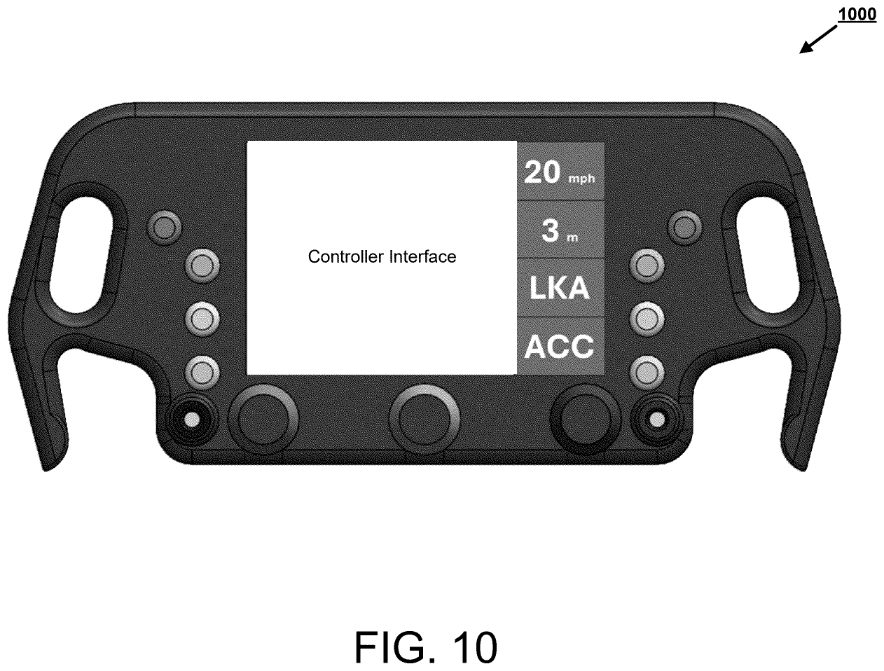

FIG. 10 is an example user controller interface 1000 for interacting with a controller subsystem in accordance with some embodiments of the present disclosure. In some embodiments, the controller subsystem 800 may be operated and/or configured with the user controller interface 1000. The user controller interface 1000 may comprise various physical switches, knobs, and joysticks that may be used to control a vehicle subsystem and an attacker subsystem. In some embodiments, the controller subsystem 800 may additionally be configured via a touch screen that allows a user to use customizable switches and buttons that are less critical in terms of controlling real time functions and/or parameters. Changing modes and adding numerical values that do not change during the experiment may also be configured with the touch screen.

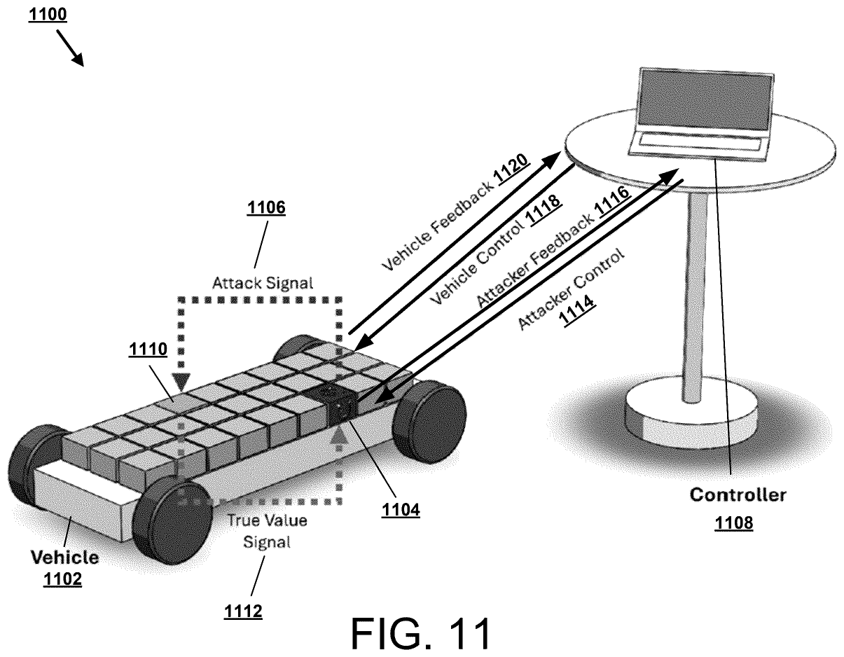

FIG. 11 is an example vehicle security analysis platform configuration 1100 in accordance with some embodiments of the present disclosure. According to some embodiments, the disclosed vehicle security analysis platform may enable a user to test internal attacks. An internal attack may originate from within a vehicle subsystem. Internal attacks may comprise attacks that are performed by a malicious participant that exists within a vehicle subsystem 1102. This may happen if an untrusted aftermarket component is integrated into the vehicle subsystem. In some embodiments, an attack signal 1106 that is associated with a malicious participant 1104 may be simulated, via a controller subsystem 1108, in the vehicle subsystem 1102 and transmitted to another (victim) module 1110 in the vehicle subsystem 1102. The module 1110 may behave as per the attack signal 1106. In some embodiments, ground truth information in the form of a true value signal 1112 may be acquired or determined, via the controller subsystem 1108, to perform post-processing analysis. The attacker control data 1114, attacker feedback data 1116, vehicle control data 1118, and vehicle feedback data 1120 may be transmitted from and to the controller subsystem 1108.

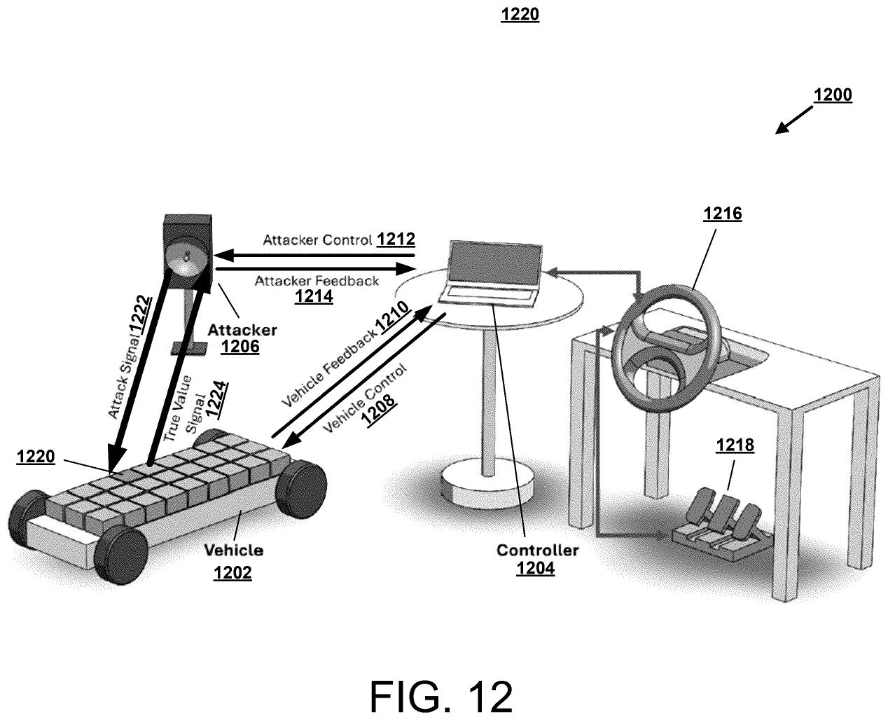

FIG. 12 is an example vehicle security analysis platform configuration 1200 in accordance with some embodiments of the present disclosure. According to some embodiments, the disclosed vehicle security analysis platform may enable a user to test external attacks. External attacks may comprise attacks on a vehicle subsystem 1202 from an external entity. In some embodiments, the vehicle subsystem 1202 may be provided with specific vehicle control commands 1208, via a controller subsystem 1204, to perform. The vehicle control commands 1208 may comprise either static or dynamic activities. The vehicle control commands 1208 may further comprise control commands received from steering wheel 1216 or pedals 1218. Vehicle feedback 1210 messages may be received, via the controller subsystem 1204, from the vehicle subsystem 1202 to evaluate the operation of the vehicle subsystem 1202.

In some embodiments, attacker control 1212 commands to perform an external attack are provided, via the controller subsystem 1204, to an attacker subsystem 1206. In some embodiments, attacker feedback 1214 messages may be received, via the controller subsystem 1204, from the attacker subsystem 1206 to evaluate the outcome and the strength of the attack. In some embodiments, external attacks may be performed with multiple attacker subsystems and vehicle subsystems. In experiments involving multiple vehicle subsystems, one of a plurality of vehicle subsystems may be configured as an attacker subsystem. An example of such a situation is V2V attacks on communication systems. A victim module 1220 may behave as per the attack signal 1222. The true value signal 1224 may be acquired or determined, via the controller subsystem 1204, to perform post-processing analysis.

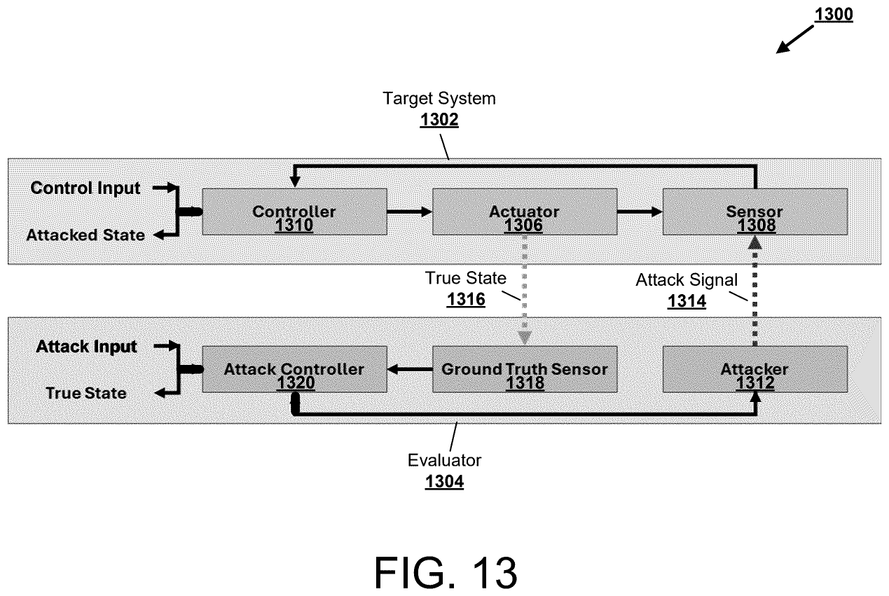

FIG. 13 is an example architecture of a cyber-physical system platform 1300 in accordance with some embodiments of the present disclosure. The cyber-physical system platform 1300 may function as an educational tool by relying on feedback, which may help users determine whether they are progressing correctly—whether they are effectively identifying vulnerabilities or successfully building and testing resilience. This is enabled through a unique architecture that comprises a target system 1302 and an evaluator 1304.

As an example, the target system—representative of a vehicle—comprises one or more actuators 1306 controlled through a closed-loop system. In this loop, a sensor 1308 may measure the one or more actuators' 1306 state, and a controller 1310 may measure the actuator and use that information to adjust the one or more actuators 1306 to reach a desired state.

The evaluator 1304 may introduce an attacker 1312 that is controlled by an attack controller 1320 and targets the sensor 1308 within the control loop with an attack signal 1314. By compromising the sensor 1308, the attacker 1312 may provide false data to the controller 1310, leading to incorrect actuator (1306) behavior.

To assess whether attacks made by attacker 1312 are effective, a true state 1316 of the target system 1302 is determined. However, the (compromised) sensor 1308 may not be able to accurately provide the actual system state. As such, an additional, uncompromised, ground truth sensor 1318 is provided specifically to monitor and report the true state 1316. The ground truth sensor 1318 may be trusted to send accurate feedback to the user, thereby allowing the user to evaluate the impact of an attack and the resilience of the target system 1302.

### CONCLUSION

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A system comprising:
a vehicle subsystem comprising a plurality of modules and a vehicle chassis, wherein the plurality of modules (i) comprises mechanical or electronic components that simulate one or more vehicle or vehicle electronic functionalities, (ii) comprises a modular form factor corresponding to the vehicle chassis, and (iii) is coupled to a vehicle computer;
an attacker subsystem configured to attack a module of the plurality of modules; and
a controller subsystem configured to control operation of the vehicle subsystem and the attacker subsystem by (i) providing (a) a vehicle control command to the vehicle subsystem and (b) an attacker control command to the attacker subsystem and (ii) receiving (a) vehicle feedback from the vehicle subsystem and (b) attacker feedback from the attacker subsystem.

2. The system of claim 1, wherein the vehicle subsystem comprises one or more of a locomotion module group, a sensing module group, a communication module group, or a power management module.

3. The system of claim 2, wherein the locomotion module group comprises one or more of a drivetrain module, a steering module, or a braking module.

4. The system of claim 3, wherein (i) the drivetrain module is configured to control longitudinal motion associated with acceleration of the vehicle subsystem, (ii) the steering module is configured to control lateral motion of the vehicle subsystem, and (iii) the braking module is configured to control longitudinal motion associated with deceleration of the vehicle subsystem.

5. The system of claim 3, wherein (i) the controller subsystem is further configured to provide a motion command to the steering module, the drivetrain module, or the braking module and (ii) the vehicle computer is further configured to receive feedback or performance data from the steering module, the drivetrain module, or the braking module based on an operation in accordance with the motion command.

6. The system of claim 2, wherein the sensing module group comprises one or more of a perception sensor, a localization sensor, a vehicle motion sensor, or a performance and health sensor.

7. The system of claim 6, wherein (i) the perception sensor is configured to collect data that is associated with decision-making and path planning, (ii) the localization sensor is configured to provide navigation or driver assistance functionality, (iii) the vehicle motion sensor comprises a wheel speed sensor, a tire-pressure monitoring system sensor, a steering position sensor, or a steering torque sensor, and (iv) the performance and health sensor is configured to monitor performance and health of the vehicle subsystem.

8. The system of claim 2, wherein the communication module group comprises one or more of an internal communication module, an external communication module, a remote communication module, or a redundant control module.

9. The system of claim 8, wherein (i) the internal communication module is configured to transfer data between the plurality of modules within the vehicle subsystem, (ii) the external communication module is configured to send or receive data between the vehicle subsystem and an environmental infrastructure, (iii) the remote communication module is configured to send control data to, and receive a feedback message from, the vehicle subsystem or the attacker subsystem, and (iv) the redundant control module is configured to control safe vehicle operation.

10. The system of claim 2, wherein the power management module is configured to manage an energy storage device in providing power to the vehicle subsystem.

11. The system of claim 2, wherein the power management module comprises (i) a high voltage module that is associated with providing high voltage for traction and (ii) a low voltage module associated with one or more electronic control units or microcontrollers.

12. The system of claim 1, wherein the attacker subsystem comprises one or more of an attacker group module, a feedback sensor, an actuator, or a power management module.

13. The system of claim 12, wherein the attacker group module comprises an ultrasonic transducer, a millimeter wave or infrared emitter, or a laser.

14. The system of claim 12, wherein the feedback sensor comprises an ultrasonic sensor, a radar sensor, a light detection and ranging (LiDAR) sensor, or a camera that is configured to detect an attack on a sensor, process, or program that operates in conjunction with a target sensor that captures ground truth information.

15. The system of claim 14, wherein a deviation from information provided by the feedback sensor with respect to the target sensor is representative of a successful attack.

16. The system of claim 15, wherein a magnitude of the deviation corresponds to a strength of the successful attack.

17. The system of claim 1, wherein the controller subsystem comprises a vehicle control parameters module that is configured to provide a parameter as the vehicle control command.

18. The system of claim 17, wherein the parameter comprises velocity, heading, or steering angle.

19. The system of claim 1, wherein the controller subsystem comprises an attacker control parameters module that is configured to provide a parameter as the attacker control command.

20. The system of claim 19, wherein the parameter comprises trigger rate, trigger frequency, height, or azimuth.
